(19) United States
(12) Patent Application Publication
(10) Pub. No.: US 2014/0006248 A1
(43) Pub. Date: Jan. 2, 2014

(54) Context Display for a Fixed Income Market Model System

(71) Applicant: Bloomberg L.P., New York, NY (US)

(72) Inventor: James W. Toffee, New York, NY (US)

(73) Assignee: Bloomberg L.P., New York, NY (US)

(21) Appl. No.: 13/927,918

(22) Filed: Jun. 26, 2013

Related U.S. Application Data
(60) Provisional application No. 61/665,241, filed on Jun. 27, 2012.
(60) Provisional application No. 61/665,180, filed on Jun. 27, 2012.

(51) Int. Cl. G06Q 40/04

(52) U.S. Cl. CPC G06Q 40/04
USPC 705/37

(57) ABSTRACT

A system for performing a computer-based method and a computer-based method include: receiving, at a computer-based interface device, data that is determined to be relevant to estimating cost information associated with a transfer of a low liquidity security; calculating, with a computer-based processor coupled to the computer-based interface device, an estimated fair value for the low liquidity security, based on the received data; receiving, at the computer-based interface device, an indication of at least one of an executable bid for the financial instrument and an executable offer for the financial instrument; and presenting, for display at a user interface terminal, a scaled, graphical representation of the estimated fair value for the low liquidity security and at least one of the executable bid for the financial instrument and the executable offer for the financial instrument.

### RELATED APPLICATIONS

This application claims priority to U.S. Provisional Application Nos. 61/665,241 and 61/665,180, both filed on Jun. 27, 2012, the disclosures of both of which are incorporated herein by reference.

### FIELD OF THE DISCLOSURE

This disclosure relates generally to fixed income securities, and more particularly to providing context for fixed income securities transactions.

### BACKGROUND

In general, financial assets can be classified as either 1) high liquidity assets; or 2) low liquidity assets. High liquidity assets generally include assets that are traditionally exchange traded, such as equity securities, while low liquidity assets generally include assets that are bought and sold in the Over the Counter (“OTC”) market such as fixed income securities.

It is generally desirable to increase transparency and liquidity, particularly in connection with markets for low liquidity assets.

### SUMMARY

In one aspect, a computer-based method includes receiving, at a computer-based interface device, data that is determined to be relevant to estimating cost information associated with a transfer of a low liquidity security; calculating, with a computer-based processor coupled to the computer-based interface device, an estimated fair value for the low liquidity security, based on the received data; receiving, at the computer-based interface device, an indication of at least one of an executable bid for the financial instrument and an executable offer for the financial instrument; and presenting, for display at a user interface terminal, a scaled, graphical representation of the estimated fair value for the low liquidity security and at least one of the executable bid for the financial instrument and the executable offer for the financial instrument.

In some implementations, one or more of the following advantages are present. For example, users are provided with context and a corresponding deeper understanding of trading opportunities (e.g., executable bids and offers) in low liquidity securities. In general, this can increases liquidity and transparency in the low liquidity securities markets. The invention also allows users to easily compare multiple transaction opportunities and assess opportunities in the abstract.

### BRIEF DESCRIPTION OF THE DRAWINGS

FIG. 1A is a schematic diagram representing exemplary relationships among various parties in a two-tiered OTC marketplace;

FIG. 1B is a schematic representation of buyer and seller interactions in the two-tiered OTC marketplace of FIG. 1A;

FIG. 2A is schematic diagram representing exemplary relationships among market participants in a single-tiered OTC marketplace that includes a computer-based platform to facilitate financial transactions between the market participants;

FIG. 2B is a schematic representation of buyer and seller interactions in the single-tiered OTC marketplace of FIG. 2A;

FIG. 3 is a schematic diagram of an exemplary system that includes a detailed example of the computer-based platform in FIG. 2A;

FIG. 4 is an exemplary user interface that can be used to implement the context bar of the present invention in the computer-based platform of FIG. 2A in the exemplary system of FIG. 3;

FIG. 5 is a second view of the exemplary user interface of FIG. 4 that shows additional features of the implementation; and

FIG. 6 is a flowchart showing the incorporation of the context bar of the present 25 invention into the user interface of FIG. 4.

### DETAILED DESCRIPTION

The present disclosure related relates to a computer system and computer-based method for producing and presenting tool to facilitate evaluating potential transactions for low liquidity securities, including OTC securities in the financial services industry.

### Overview and Fundamentals

An overview of the art is provided to assist the reader's appreciation of the context of this specification, as well as some of the problems that can be solved by certain implementations of systems and methods described herein.

In general, financial assets can be classified as either 1) high liquidity assets; or 2) low liquidity assets. For the purposes of this disclosure, exchange traded assets, such as stocks and other equity based securities will be considered high liquidity assets and Over the Counter (“OTC”) assets, such as fixed income securities and derivatives, will be considered low liquidity assets. The terms “exchange-traded” and “OTC” are used to denote assets that are traditionally traded in that manner. The marketplace for exchange-traded assets is very active and highly-transparent. OTC assets, on the other hand, are generally not traded over an exchange. Instead, they are traded directly between parties or through one or more brokers. The market for OTC assets is much less active than the marketplace for exchange-traded assets. For example, in a typical trading day, only about 4-5% of existing corporate bonds have a trade. So, there is generally much less publically available data for interested parties about OTC trades than exchange-based trades.

The current OTC, or fixed income security model consists of manual person-to-person exchanges in two different markets. The first market is the dealer to dealer market. Institutional investors rely on the dealer to dealer market to (1) find or provide liquidity for securities, (2) locate the best price on those securities, (3) gauge the quality of that best price, and (4) match buyers and sellers to execute desired trades. When looking to transact in fixed income securities in the dealer to dealer market, investors must give an indication of their intention to trade (sometimes referred to as “indications of interest” or simply “JOIs”). This indication can be given in many forms, e.g., emails, phone calls, bid lists, and axe sheets. In theory, these sources combine to create a small measure of market data on what are generally regarded to be relatively illiquid securities. As a result of the incompleteness of this market data, by some estimates, 97% of the corporate bond market is “dark”—customers have no way to contextualize potential transactions.

The transparency in the first market (dealer to dealer) has benefitted dealers, granting them an “information arbitrage” over their customers who must participate in the second market (dealer to customer). Part of this is due simply to the fact that institutional customers do not have access to the existing dealer to dealer market. In reality, however, giving customers access to the dealer to dealer market would present customers with a different, more fundamental set of problems that plague the fixed income market. Such problems include a lack of real-time market data and a lack of systems for (1) aggregating and presenting that real-time market data, (2) finding liquidity without having to expose orders to the entire market, (3) initiating and responding to trades, and (4) assessing the quality of a proposed transaction. The primary focus of this disclosure is addressing the fourth factor—assessing the quality of a proposed transaction.

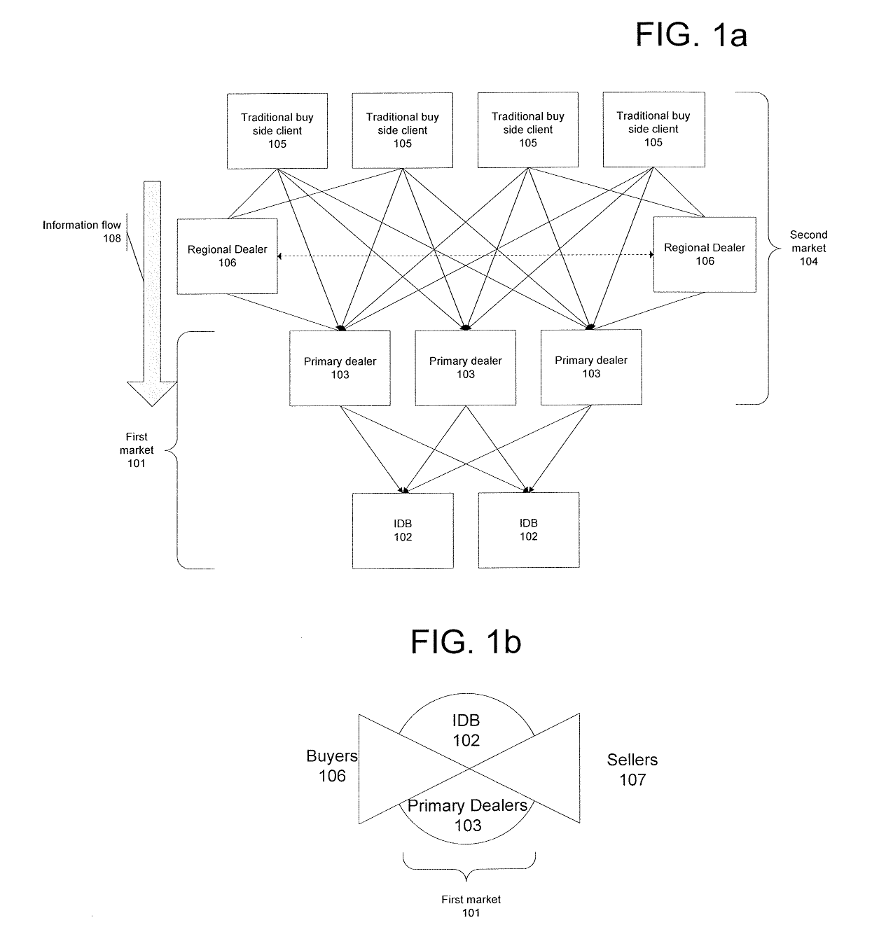

By way of illustration, FIG. 1A shows an example of a traditional two tier marketplace. In the illustrated marketplace, the first market 101 is a marketplace in which primary dealers 103 compete. The primary dealers 103 have access to several Inter-Dealer Broker systems (IDB) 102. The primary dealers 103 trade with each other using the IDB systems 102 in the first market 101. The IDB systems 102 include automated systems for posting and viewing available liquidity in the fixed income security marketplace, but are generally only available to dealers. The data contained in the IDB systems 102 thus provide a limited view of the state of the fixed income security market.

The first market 101 carries large amounts of information, with a fairly open flow of information between the primary dealers 103. This leads to a first market 101 that is generally more transparent and has lower bid-ask spreads than the second market 104.

The second market 104, on the other hand, includes traditional buy side clients 105 trading with the primary dealers 103. To trade, the traditional buy side clients 105 generally give substantial amounts of information 108 to the primary dealers 103 so that the primary dealers 103 can generate quotes. Because of the information disparity that this creates, the second market 103 generally trades with much lower transparency and much larger bid-ask spreads than the first market 101.

Regional dealers 106 occasionally exist between traditional buy side clients 105 and primary dealers 103. Although the regional dealers 206 may trade with each other, they generally do not have access to IDBs 102, and therefore cannot access the majority of information and efficiencies produced in the first market 101. Regional dealers 106 often use primary dealers 103 in order to access liquidity.

FIG. 1B is a schematic representation of the fixed income security market of FIG. I A, with buyers 105a and sellers 105b trying to reach each other, but being constrained largely by first market 101 (represented by the pinch point between the two sides of the bowtie shape). Within the first market 101, the primary dealers 103 use the IDB systems 102 to deal with each other, and then transmit the securities from buyer 106 to seller 107. The buyers 106 and the sellers 107 give a lot of information to the primary dealers 103, but the primary dealers 103 give very little information back to them.

### The Single Tier Fixed Income Market Model

An implementation of a single tier fixed income market model employs a trading system platform that comprises an “all-to-all” protocol, replacing the previous customer to dealer and dealer to dealer marketplaces. This market model provides for direct trading of fixed income securities between institutional investors, brokers, and others. Trading in such a system can be automated.

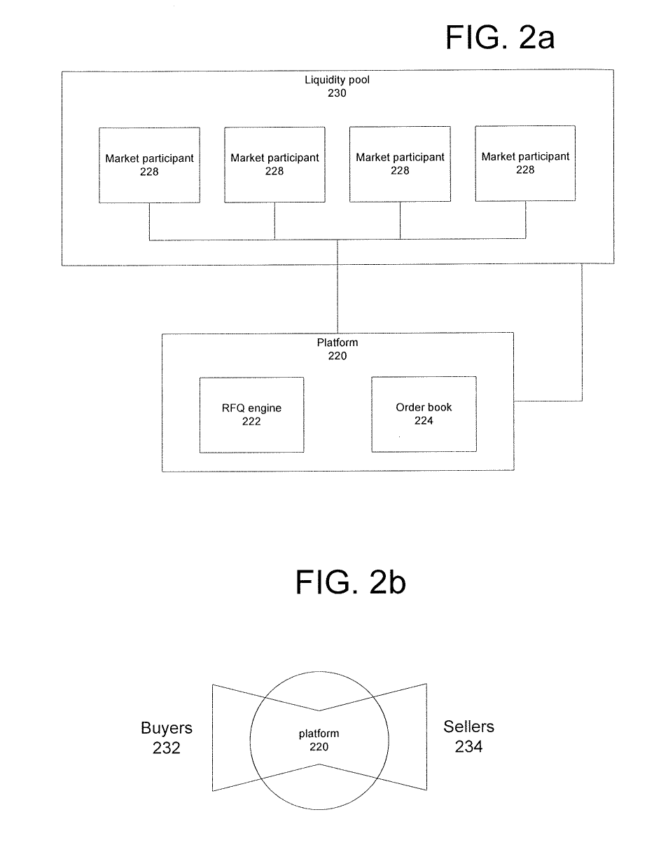

FIG. 2A shows an implementation of the single tier fixed income market model. The market model is implemented using a trading system platform 220. The system platform 220 is adapted to support computer-based all-to-all request-for-quotation (“RFQ”) functionality 222 and order book functionality 224. In general, the RFQ functionality enables users within a liquidity pool 230 (e.g., market participants 228) to request quotations from other users for a desired financial transaction involving the transfer of one or more fixed income securities. In general, the order book functionality 224 provides each user with a listing of assets that the various users have orders posted for.

As discussed in further detail herein, the market participants 228 can access the system platform 220 from computer terminals, handheld mobile devices, or the like that are coupled to the system platform 220, for example, by a computer network, such as the Internet.

In some implementations, the RFQ functionality 222 of the system platform 220 can enable market participants 228 (e.g., buyers and sellers) to find counterparty buyers and sellers. Typically, this functionality relates to traditionally illiquid securities, such as bonds.

Additionally, the system platform 220 typically can be used by market participants 228 to investigate multiple bids or offers on one or more bonds. In some implementations, the order-book functionality 224 enables market participants to access various trading opportunities posted by other market participants. This information can be presented in a variety of ways and may be searchable, sortable, etc.

FIG. 2B is a schematic representation of the fixed income security market of FIG. 2A, with buyers 232 and sellers 234 able to deal directly with each other using the platform 220 as a link.

Even after a transition from the marketplace illustrated in FIG. 1 towards the marketplace illustrated in FIG. 2, users of a fixed income security marketplace such as that illustrated in FIG. 2 will be at a tremendous disadvantage in assessing the quality of any offers provided. Dealers will retain their information advantage, and users will continue to not have the proprietary information or experience to properly contextualize any offers they receive, either directly in response to an RFQ or indirectly through order book functionality. For these reasons, and others, the OTC marketplace has been largely opaque, particularly as compared to the exchange-traded marketplace. This lack of transparency is a barrier to trading and participating in the OTC marketplace. Indeed, it is very difficult for interested parties to determine a fair price for a proposed trade.

In the early 2000s, the Financial Industry Regulatory Authority (“FINRA”) introduced the Trade Reporting and Compliance Engine (“TRACE”) in an effort to increase transparency in the U.S. corporate debt market. In general, TRACE reports on various OTC transactions. Although TRACE has had some success in increasing the amount of publically-available information about OTC transactions, there remains significant room for further advances to increase transparency in the OTC marketplace, and helping interested parties arrive at a “fair price” for transactions that involve OTC assets.

If a user were to be presented with bids or offers in the abstract, as they would be in an order book context, or in response to an RFQ, as they would in request based system, the numbers received by the user would not provide the information necessary to properly assess the quality of the proposed transaction. Similarly, if a user were to be presented with multiple potential transactions for multiple financial products, they would have trouble comparing the quality of the proposed transactions to each other and to the marketplace as a whole. When viewing an order book with several executable transactions, a user would therefore have great difficulty assessing which opportunities, if any, are worth pursuing.

In some implementations, the problem of assisting a user in properly contextualizing an executable bid or offer in fixed income securities is solved by:
1. Displaying currently available volume.
2. Displaying a visualization of contemporaneous expected transaction valuations.
3. Visually placing the bids and offers in the context of that visualization.

This visualization can be incorporated into various displays including order book displays (where any asset with any volume will have an associated context bar, which may include, for example, the visualization of contemporaneous expected transaction valuations and the bids and offers placed in the context of that visualization) and/or financial information displays (where a context bar is provided for any asset in which volume exists within an associated system). Users could then, for example, click on the context bar to view an associated display. The associated display can be, for example, the TRACE display as disclosed in FIG. 1 of patent application Ser. No. 13/492,641, filed Jun. 8, 2012 and entitled “Fixed Income Securities Market Data Display.”

### Overview of an Exemplary System for Implementing a Context Display for Fixed Income Securities

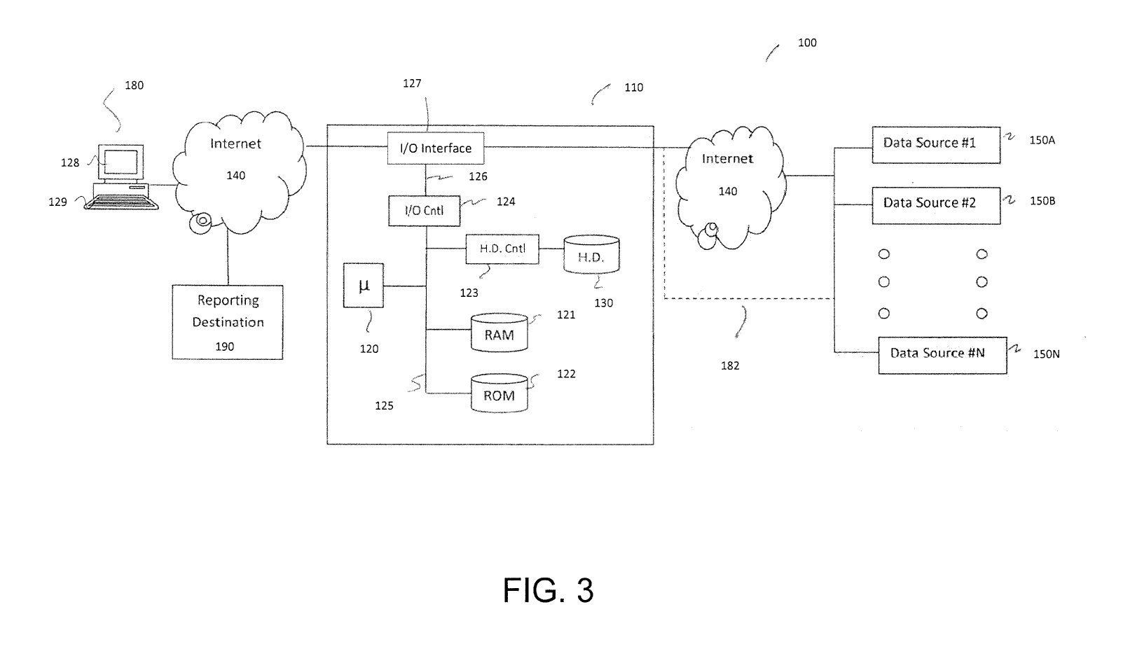

One or more of the operations described in this specification can be implemented by a system that includes one or more data processing apparatuses, one or more computer readable storage devices and a variety of data sources. FIG. 3 is a schematic representation showing an example of such a system 100 adapted to implement one or more of the operations described herein.

In particular, the system 100 is adapted to receive data that is relevant (e.g., determined by the system or by a system operator to be relevant) to estimating cost information associated with a transfer of a low liquidity security (e.g., a financial instrument traditionally available only over-the-counter). This data can come from a variety of data sources. The system calculates a valuation for the low liquidity security based on the received data. The valuation can include an estimated fair price for the low liquidity security and/or an estimated bid-offer spread for the financial instrument. The system is also configured so that it can receive from system users one or more executable bids for the low liquidity security and/or one or more executable offers for the low liquidity security. Additionally, the system is configured to present, for display at one or more user interface terminals, a scaled, graphical representation of the estimated fair price and/or the estimated bid-offer spread and/or executable bid or offer information received.

The illustrated system 100 includes a data processing apparatus, such as a programmable processing system 110. The programmable processing system 110 is coupled via the internet 140 to a user terminal 180 and a plurality of data sources 150A, 150B . . . 150N. In some implementations, it is further configured to access via the internet 140 one or more external marketplaces for transacting in assets. As indicated by dashed line 182, one or more of the data sources 150A, 150B . . . 150N may be connected directly to the processing system 110.

The programmable processing system 110 includes a processer 120, a random access memory (RAM) 121, a program memory 122 (for example, a writable read-only memory (ROM) such as flash ROM), a hard drive 130, a hard drive controller 123, and an input/output (I/O) controller 124 coupled to one another by a processor (CPU) bus 125. The programmable processing system 110 also has an input/output interface 127 coupled to the I/O controller 124 by an I/O bus 126.

In general, the system 110 can be programmed by loading a program from any convenient program source (for example, from a floppy disk, a CD-ROM, or another computer).

In general, the hard disk 130 is suitable for storing executable computer programs, including programs embodying aspects of the subject matter described in this specification, and data discussed in this specification.

In general, the I/O interface 127 receives and transmits data (e.g., financial data and reporting data) in analog or digital form over communication links such as a serial link, local area network, wireless link, and parallel link as well as the internet 140. The I/O interface 127, in the illustrated system 100, is connected to a user terminal 180 via the internet 140. The user terminal 180 has a display 128 (i.e., a visual display) and a keyboard 129.

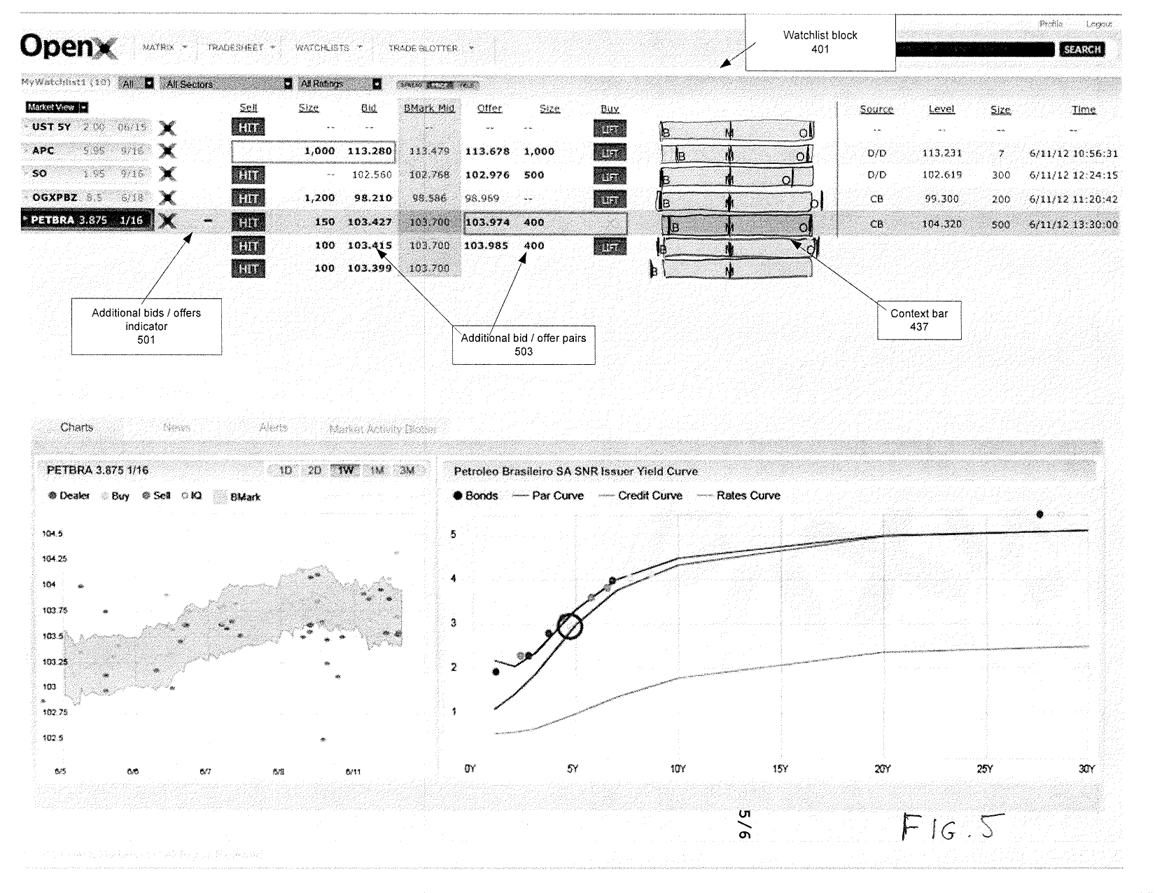

In one aspect, the I/O interface 127 is operable as a market data interface for receiving data and representing information related to financial data. In another aspect, the I/O interface 127 is operable as a transaction data interface for receiving data and representing a series of financial market observations over a period of time. In a typical implementation, the data can be obtained from one or more data sources (e.g., 150A, 150B . . . 150N in FIG. 5). The data sources can include, for example, a computer terminal where data is entered manually. Other examples of data sources include, for example, FINRA's TRACE, information from market makers, including quotes provided by dealers directly to their buy-side customers over the telephone, end-of-day (EOD) quotes to market data vendors such as Marklt, International Data Corporation (IDC) and Bloomberg, and intraday indicative quotes via emails that are parsed by other market vendors such as Marklt, Credit Market Analysis (CMA) and Bloomberg. The I/O interface 127 also provides an access point for a user at user terminal 180 or at a reporting destination 190 to interact with and access the data and functionality disclosed herein.

The processor 120 may be adapted to calculate (or receive) and store a reference value of an asset based on the series of financial market observations and for identifying a set of transaction data points associated with an asset. This information, among other information, can be stored in an electronic database, for example, in RAM module 121. The display 128 and the keyboard 129 can, in a typical implementation, form an exemplary user interface. The display 128 is generally configured to present information to user that would be useful for that user. This can include, for example, a display of the contextualization of a specified potential transaction.

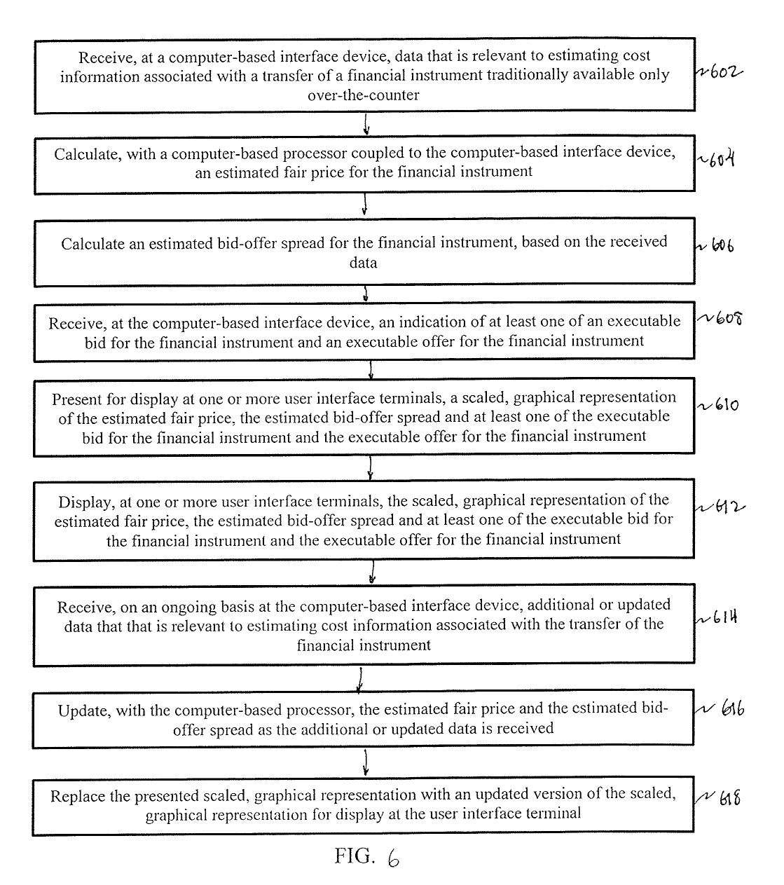

FIG. 6 is a flowchart showing an exemplary implementation of a process that the system 100 in FIG. 3, for example, may implement to create and present at user terminal 180 a graphical representation of data that the user may find helpful in contextualizing (i.e., putting into a broader context) available executable bids and offers for one or more low liquidity securities.

According to the illustrated method, the processing system 110 receives (at 602), at its I/O interface 127, data that is relevant to estimating cost information associated with a transfer of a financial instrument traditionally available only over-the-counter (i.e., a particular type of low liquidity security).

Examples of data that may be relevant to estimating cost information associated with the transfer of the financial instrument include: 1) information associated with other previous transfers of the financial instrument in question; 2) information associated with previous transfers of financial instruments in the same or a similar industry as the financial instrument in question; 3) information associated with previous transfers of financial instruments in the same or a similar maturity bucket; 4) information associated with previous transfers of financial instruments with the same or a similar rating; 5) information associated with previous transfers of financial instruments with the same or a similar % yield; and 6) general observations of publicly available information in the marketplace that a trader of the specified type of financial instrument would rely on.

In general, the data that may be relevant to estimating cost information can come from one or more data sources, such as data sources 150A-150N in FIG. 3.

Next, the processing system 110 uses its processor 120 to calculate (at 604) to calculate an estimated fair price for the financial instrument, based on the received data. In general, the calculation takes into account various data that may be relevant to calculating a fair price for the financial instrument. Typically, however, the calculation does not take into account data associated with a current, executable bid or offer for the particular financial instrument in question. In general, the estimated fair price is an attempt to predict a price for a transfer of the financial instrument between two parties having substantially equal bargaining power that would be fair to both parties given current or substantially current market conditions.

Next, the processing system 110 uses its processor 120 to calculate (at 606) an estimated bid-offer spread for the financial instrument, based on the received data. In general, the calculation takes into account various data that may be relevant to calculating an estimated bid-offer spread for the financial instrument. Typically, however, the calculation does not take into account data associated with a current, executable bid or offer for the particular financial instrument in question.

According to the illustrated method, the processing system 110 (at 608) receives at its I/O interface 127, an indication of at least one of an executable bid for the financial instrument and an executable offer for the financial instrument. In a typical implementation, each indication is an electronic message indicating that a user has entered information at a particular one of the user terminals in the system 100 that he or she is placing a bid or making an offer for the particular financial instrument in question. Usually, the indication will include price information that comes from the user.

The indication of the executable bid for the financial instrument and/or the indication of the executable offer for the financial instrument may come from different interface terminals, such as user interface terminal 180, in the system 100 of FIG. 3. For example, an executable bid indication may come from a first user interface terminal and an offer indication may come from a second user interface terminal.

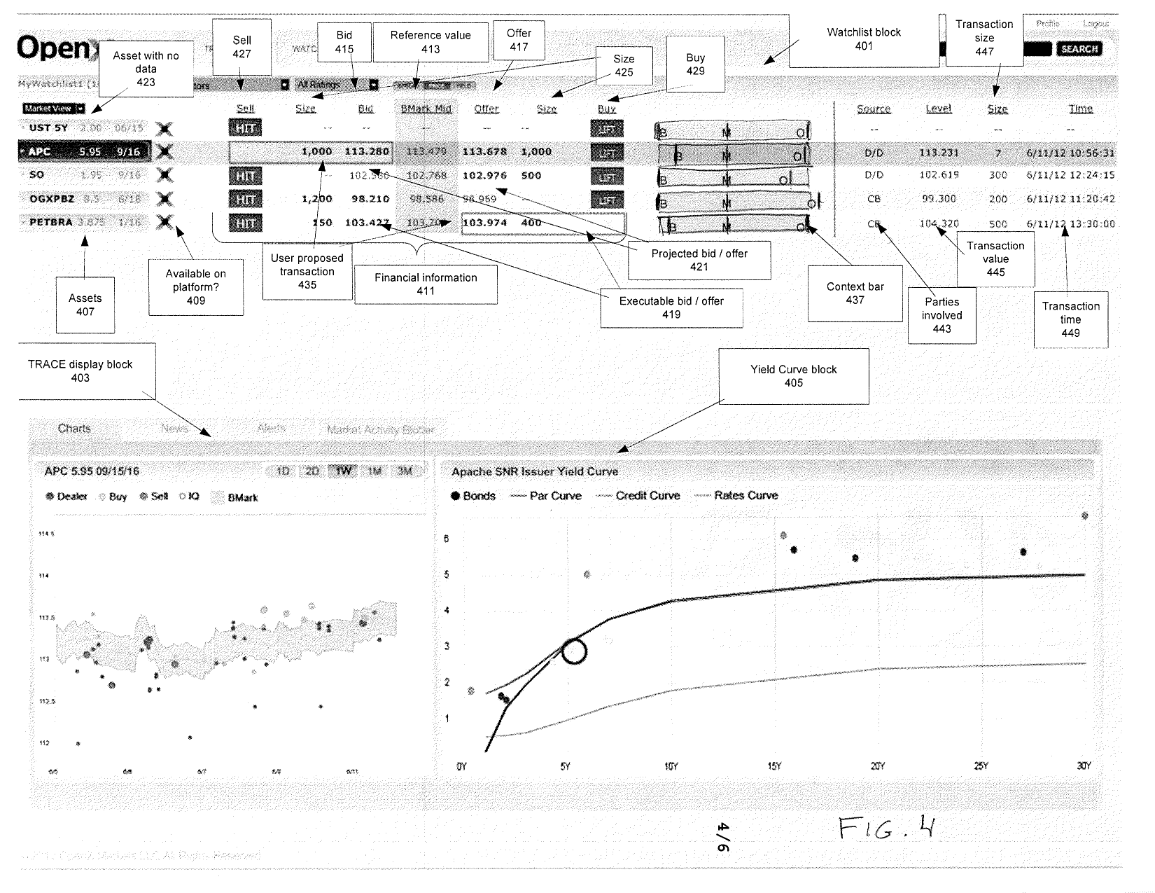

Next, the processing system 110 (at 610) presents for display at one or more of the user interface terminals, a scaled, graphical representation of the estimated fair price, the estimated bid-offer spread and the executable bid and/or executable offer. Examples of the scaled, graphical representation (referred to as context bars 437) are shown in FIG. 4 and of the present application.

The scaled, graphical representation is presented (at 612) at one or more user terminals, such as user terminal 180 in the system 100 of FIG. 3. In a typical implementation, the scaled, graphical representation is integrated into a visual display, such as the visual display shown in FIG. 4, which includes other information regarding the financial instrument in question. Typically, the scaled, graphical representation is presented in a visual display as part of a listing information about several different financial instruments, with a unique scaled, graphical representation for each one of the listed financial instruments.

According to the illustrated implementation, the processing system 110 (at 614) continues to receive additional or updated data, at its I/O interface 127, on an ongoing basis, that may be relevant to estimating cost information associated with the transfer of the financial instrument. As the additional or updated data becomes available (at 614), the processing system 110 (at 616) uses its processor 120 to update the estimated fair price and the estimated bid-offer spread.

Once the updated estimates have been calculated, the system 100 (at 618) replaces the scaled, graphical representation with an updated version of the scaled, graphical representation for display at one of the user terminals.

FIGS. 4-5 show implementations of a user interface for implementing a context display for a fixed income market model. When the process of “displaying” or “presenting” is described in this disclosure, it is understood to include the concept of causing to be displayed or presented (e.g., transmitting data that is then rendered for display or presentation at a user terminal).

Both figures show a screen comprising a Watchlist block 401, a TRACE Display block 403, and a Yield Curve block, 405. Examples of displays that can be used for the TRACE Display block 403 and the Yield Curve block 405 can be found, for example, in FIG. 1 and FIG. 8B in patent application Ser. No. 13/492,641, filed Jun. 8, 2012 and entitled “Fixed Income Securities Market Data Display.”

The Watchlist block 401 of FIG. 4 shows an implementation of a context display for fixed income securities. As shown in the illustrative embodiment, the Watchlist block 401 comprises a list of identified assets 407 followed by various information related to the assets. In the embodiment, the user has previously selected assets to be included in a watchlist. In alternative embodiments, these assets are selected in an automated fashion, such as the components of a specified financial index, or some set of assets that are the most traded over some period of time. Immediately to the right of the asset identifications 407 is an indication 409 of whether an asset is available through a specified transaction platform. To the right of the indication 409 is a set of seven columns of financial information 411 that will be described together. In alternative embodiments, the user is free to select what information is displayed for the list of assets 407. The center column 413, which is highlighted in the display, shows a reference value (e.g., an estimated fair price) of the asset/financial instrument identified. In the illustrated embodiment, this value is the average of a bid reference value and an offer reference value. The center column 413 is flanked by columns labeled bid 415 and offer 417. These columns show either an executable bid or offer 419 or a projected bid or offer 421. In some embodiments, the entries under the “bid” and “offer” headings can be color-coded to identify whether the listed “bid” or listed “offer” is projected or executable. For example, in one embodiment, a projected bid or offer 421 is shown in white and an executable bid or offer 419 is shown in yellow. If the system does not have a projected price for an asset, the relevant data fields may be left blank, as shown in the row related to UST 5Y 423.

In the illustrated embodiment, each reference value represents a substantially contemporaneous estimate (i.e., substantially up-to-date with respect to a current point in time). That is to say, the reference value represents a projected transaction value for the low liquidity security for the same point in time as the corresponding transaction data point in the list. Thus, the reference value may be, in part, time-dependent. Variations in reference value can be based on parameters such as changes in transaction values associated with other securities in the market data, trade volume of other securities in the market data, and/or transaction timing (e.g., how often a security is exchanged) of other securities in the market data.

A reference value can correspond to, for example, a reference price or a reference yield for the particular type of security being evaluated. Each reference value is calculated using information obtained from the received market data. In particular, the reference values may be, for example, calculated based on prices and/or yields of low liquidity securities that are comparable or similar to a security being evaluated. However, the reference value is independent of any specified transaction data point. For example, if the low liquidity security being analyzed is a corporate bond issued from a company in the semiconductor industry, then a reference value for a transaction associated with that bond can be calculated based on prices and/or yields of bonds (or other low liquidity securities) issued by other entities in the semiconductor industry as well as prices and/or yields of other transactions in that bond.

Surrounding the bid 415 and offer 417 columns are columns labeled size 425. If an executable bid or offer is present, the size column 425 will display the volume available at the executable price. If there is no executable bid or offer price, the size column 419 will be blank. Surrounding the size columns 425 are columns labeled sell 427 and buy 429. These columns provide a user with an option to either hit an executable bid 415 or lift an executable offer 417. In the illustrated embodiment, the user can also provide his or her own executable bids or offers. If a user provides an executable bid or offer, the relevant data is highlighted in blue 435. Since a user cannot hit or lift his own bid or offer, the option to do so is replaced by an X, which can be used to cancel the executable proposed transaction.

To the right of the pricing information is a context bar 437 (i.e., a scaled, graphical representation) provided for each asset.

In the illustrated implementation, each scaled, graphical representation (i.e., each context bar 437) includes a bar-shaped visual element. The bar-shaped visual element has a first end (e.g., the left end in the illustrated implementation) that represents the estimated bid price calculated by processor 120, for example, and a second end (e.g., the right end in the illustrated implementation) that represents the estimated offer price calculated by processor 120, for example.

In the illustrated implementation, the length between the first end and the second end of the bar-shaped visual element is set (i.e., the length of every bar-shaped element in FIG. 4 is the same). Therefore, the numerical difference between the estimated bid price and the estimated offer price generally sets the scale (i.e., the incremental value associated with each unit length) across the illustrated context bars 437. For example, the length of the context bar 437 that corresponds to the low liquidity security referred to as “SO” represents a dollar amount of 0.416 (i.e., (102.768−102.560)*2)) whereas the length of the context bar 437 that corresponds to the low liquidity security referred to as “OGXPBC” represents a dollar amount of 0.766. Since the overall length of the “SO” context bar 437 is the same as the overall length of the “OGXPBC” context bar 437, the dollar amount associated with a unit length of the “OGXPBC” context bar 437 is greater than the dollar amount associated with the same unit length of the “SO” context bar 437.

Each context bar 437 shows the estimated fair price (i.e., the estimated fair price calculated by processor 120) for the corresponding low liquidity security. More particularly, in the illustrated implementation, a first marking (e.g., a vertical line with an “M” indicator) is provided to identify a first position on the bar between the first edge and the second edge. The first position on the bar corresponds to the estimated fair price along a scaled extent, based on the numerical difference between the estimated bid price and the estimated offer price that sets the scale. In each of the illustrated examples, the first marking (i.e., the estimated fair price marking) is provided at an approximate mid-point along the length of the context bar 437.

Each context bar 437 also shows an executable bid and an executable offer for the low liquidity security. More particularly, each context bar 437 includes a second marking (i.e., a vertical line with a “B”) to identify a position along the scaled extent that corresponds to an executable bid for the financial instrument and a third marking (i.e., a vertical line with an “O”) to identify a position along the scaled extent that corresponds to an executable offer for the financial instrument. In a typical implementation, the scaled extent can extend beyond the first and second edges of the bar-shaped visual element. Therefore, second and/or third markings can be inside the bar-shaped element (reflecting that the executable bid and/or offer are within the estimated bid-offer spread or the second and/or third markings can be outside the bar-shaped element (reflecting that the executable bid and/or offer are outside of the bid-offer spread). The scaling of the graphical representation beyond the ends of the bar-shaped visual element is the same as the scaling of the graphical representation inside the bar-shaped visual element.

In general, the context bar 437 represents the space between the projected bid and the projected offer 421. The center line, labeled M, represents the projected price displayed in the center column 413. The vertical line labeled B shows a bid in the context of the projected valuation, and similarly, the vertical line labeled O shows an offer in the same context. When there is no projected bid or offer available, the vertical line remains at the end of the context bar. Alternatively, the display may either be unlabeled or not shown in the event of a lack of executable bids.

The context bar 437 can be viewed as a present time representation of the information shown for the selected asset in the TRACE display block 403. When an asset is selected, the context bar 437 therefore represents the far right edge of the chart shown in TRACE display block 403. In some implementations, the displays are not shown together, and a user can access the TRACE display block 403 by clicking on the context bar. The TRACE display block can also provide additional features, such as representations of executable bids and offers. Similar features can be applied to the Yield Curve block 405. These features, and others, are described in patent application Ser. No. 61/495,793, filed Jun. 10, 2011 and Ser. No. 13/492,641, filed Jun. 8, 2012, both entitled “Fixed Income Securities Market Data Display.”

To the right of the context bars 437 are various details regarding the most recent transaction for a listed asset. In the illustrated embodiment, those details are the parties involved in the transaction 443, the value assigned to the transaction 445, the size of the transaction 447, and the time and date of the transaction 449. The Watchlist block 401 of FIG. shows additional details of the user interface for implementing a context display. In addition to the features shown in FIG. 4, the figure provides an option to drill down to see additional bids or offers for an asset. The availability of additional bids or offers is indicated by an icon 501. When the icon is activated, as in the illustrated embodiment, additional bids and/or offers 503 are shown associated with a security. These additional bids and/or offers 503 are shown in pairs, with the best bid and best offer paired, followed by the second best bid and offer and so on. Each pairing of a bid and an offer is associated with a context bar 437, allowing the user to easily gauge the quality of the depth of his order book.

A number of embodiments of the invention have been described. Nevertheless, it will be understood that various modifications may be made without departing from the spirit and scope of the invention.

For example, a context bar (e.g., context bar 437) may include additional or different markings than the markings disclosed herein. In some implementations, for example, the context bar 437 may include a marking along the bar-shaped visual element that represents the average of the executable bid and offer for the corresponding low liquidity security. The marking may be, for example, a vertical line and may be identified with the letter “A,” representing the word “average.” This average marking may be provided in addition to or instead of the marking that shows the estimated fair price for the corresponding low liquidity security.

In addition, in some implementations, the system is adapted to provide at the user terminal a quantification of one or more distances between various markings, edges, etc. in the scaled graphical representation. For example, the system may be adapted to identify the absolute distance (or percentage difference) between an executable bid or offer and one or more of aspects of the estimated fair value of the corresponding low liquidity security. More particularly, the system may be adapted to identify and/quantify the distance between an executable bid and a predicted bid price, or an executable bid and an estimated fair price, or an executable offer and a predicted offer price, or an executable offer and the estimated fair price. For example, the specific appearance of the screenshots can vary considerably.

Additionally, the exact appearance of the scaled, graphical representation (e.g., the context bar 437) can differ considerably. Color coding can be used and text sizes can be varied to reflect additional information related to the associated low liquidity security. The size of different context bars on one screenshot can be made to differ as well. Additionally, certain aspects of the functionality disclosed can be performed without a computer.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” and like terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks {e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data {e.g., an HTML page) to a client device {e.g., for purposes of displaying data to and receiving user input from a user interacting with the client device). Data generated at the client device {e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Accordingly, other implementations are within the scope of the claims.

What is claimed:

1. A computer-based method comprising:
receiving, at a computer-based interface device, data that is determined to be relevant to estimating cost information associated with a transfer of a low liquidity security;
calculating, with a computer-based processor coupled to the computer-based interface device, an estimated fair value for the low liquidity security, based on the received data;
receiving, at the computer-based interface device, an indication of at least one of an executable bid for the financial instrument and an executable offer for the financial instrument; and
presenting, for display at a user interface terminal, a scaled, graphical representation of the estimated fair value for the low liquidity security and at least one of the executable bid for the financial instrument and the executable offer for the financial instrument.

2. The computer-based method of claim 1 wherein the low liquidity security is a financial instrument traditionally available only over-the-counter,
wherein calculating the estimated fair value for the low liquidity security comprises calculating an estimated fair price for the financial instrument and an estimated bid-offer spread for the financial instrument.

3. The computer-based method of claim 1, wherein the data that is relevant to estimating cost information associated with the transfer of the low liquidity security does not include information directly related to the executable bid for the financial instrument and does not include information directly related to the executable offer for the financial instrument.

4. The computer-based method of claim 1 further comprising:
receiving, on an ongoing basis at the computer-based interface device, additional or updated data that that is relevant to estimating cost information associated with the transfer of the low liquidity security;
updating, with the computer-based processor, the estimated fair value as the additional or updated data is received; and
replacing the presented scaled, graphical representation with an updated version of the scaled, graphical representation for display at the user interface terminal.

5. The computer-based method of claim 1 further comprising:
presenting, for display at the user interface terminal, along with the scaled, graphical representation, additional information associated with the low liquidity security,
wherein the additional information associated with the low liquidity security includes one or more of: a numeric representation of the estimated fair price for the low liquidity security, a numeric representation of a bid price associated with the executable bid and a numeric representation of an offer price associated with the executable offer.

6. The computer-based method of claim 5 wherein the additional information associated with the low liquidity security further includes one or more of the following: a coupon rate, a maturity date, a size associated with the executable bid for the financial instrument, a size associated with the executable offer for the financial instrument and a numeric representation of the estimated bid-offer spread.

7. The computer-based method of claim 1 wherein the scaled, graphical representation is presented for display at the user interface terminal as part of a listing that includes other scaled, graphical representations,
wherein each of the other scaled, graphical representations in the listing corresponds to an associated one of a plurality of different low liquidity securities.

8. The computer-based method of claim 7 wherein each of the other scaled, graphical representations shows an associated estimated fair value, including an associated estimated fair price or an associated estimated fair bid-offer spread, and an associated executable bid or executable offer for a corresponding one of the low liquidity securities.

9. The computer-based method of claim 7 wherein the scaled, graphical representation and the other scaled, graphical representations are listed relative to one another for display at the user interface terminal in such a manner as to facilitate a user's comparison of relative quality of the bids and offers for the different low liquidity securities based on the respective estimated fair values.

10. The computer-based method of claim 1 wherein the scaled, graphical representation comprises:
a first visual element having:
a first edge; and
a second edge opposite the first edge; and a first marking to identify a position on the first visual element between the first edge and the second edge,
wherein the first edge corresponds to a lower end of a band defined by the estimated bid-offer spread relative to the estimated fair price,
wherein the second edge corresponds to an upper end of the band defined by the estimated bid-offer spread relative to the estimated fair price, and wherein the position on the first visual element identified by the first marking corresponds to the estimated fair price along a scaled extent that includes the first visual element.

11. The computer-based method of claim 10 wherein the position identified by the first marking is centrally located between the first edge and the second edge.

12. The computer-based method of claim 10 wherein the scaled, graphical representation further comprises at least one of:
a second marking to identify a position along the scaled extent that corresponds to the executable bid for the financial instrument; and a third marking to identify a position along the scaled extent that corresponds to the executable offer for the financial instrument.

13. The computer-based method of claim 10 wherein the first visual element appears at the user interface terminal as a bar.

14. The computer-based method of claim 13 wherein the estimated bid-offer spread defines a lower end of the bar and an upper end of the bar.

15. The computer-based method of claim 1 wherein the low liquidity security is a financial instrument in the fixed income or derivatives market.

16. The computer-based method of claim 1 wherein the indication of the at least one executable bid is received from a first remotely-located user computer terminal over a network, or wherein the indication of the at least one executable offer is received from a second remotely-located user computer terminal over the network.

17. The computer-based method of claim 1 wherein calculating the estimated fair value comprises calculating using data from or related to one or more of the following: interest rate swaps, swaption volatility; trades in the fixed income or derivatives markets reported by the Financial Industry Regulatory Authority under the Trade Reporting and Compliance Engine (TRACE) program, swap execution facilities, swap data repositories, treasury pricing, market observations, correlated bank credit default swaps, supply and demand technicals, comparable bonds and equities.

18. A computer-based method comprising:
presenting, for display at a user interface terminal, a scaled, graphical representation of: an estimated fair price for a financial instrument traditionally available only over-the-counter;
an estimated bid-offer spread for the financial instrument; and at least one of either an executable bid for the financial instrument and an executable offer for the financial instrument,
wherein the scaled, graphical representation comprises:
a bar having a first edge and a second edge, wherein the second edge is opposite the first edge;
a first marking to identify a first position on the bar between the first edge and the second edge, wherein the first position on the bar corresponds to the estimated fair price along a scaled extent that includes the bar,
wherein the first edge of the bar corresponds to a lower end of a band defined by the estimated bid-offer spread about to the estimated fair price and the second edge corresponds to an upper end of the band; and
at least one of either a second marking to identify a position along the scaled extent that corresponds to the executable bid for the financial instrument and a third marking to identify a position along the scaled extent that corresponds to the executable offer for the financial instrument.

19. The computer-based method of claim 18 wherein the financial instrument traditionally available only in the over-the-counter marketplace is a financial instrument in the fixed income and derivatives markets.

20. The computer-based method of claim 18 further comprising:
calculating the estimated fair price and the estimated bid-offer spread based on data that is not directly related to the executable bid for the financial instrument and the executable offer for the financial instrument.
